(19) United States
(12) Patent Application Publication
(10) Pub. No.: US 2026/0194257 A1
(43) Pub. Date: Jul. 9, 2026

(54) WATER HEATER APPLIANCE INLET TEMPERATURE INDICATION IN RECREATIONAL VEHICLES

(71) Applicant: Haier US Appliance Solutions, Inc., Wilmington, DE (US)

(72) Inventors: Andrew Scott Hapner, Findlay, OH (US); Richard Dustin Henderson, La Grange, KY (US); William Troyer, South Bend, IN (US)

(21) Appl. No.: 19/014,385

(22) Filed: Jan. 9, 2025

(51) Int. Cl. F24H 1/00; F24H 15/215; G01K 1/02; F24H 15/281; G01K 7/22

(52) U.S. Cl. CPC F24H 1/009; F24H 15/215; G01K 1/02; F24H 15/281; G01K 7/22

(57) ABSTRACT

A water heater appliance includes a cabinet, and a heat exchanger positioned within the cabinet. The water heater appliance also includes an inlet coupled to the cabinet. The inlet is fluidly coupled to an inlet tube. The inlet tube includes an inlet temperature sensor. A controller is positioned within the cabinet. The controller is in signal communication with the inlet temperature sensor. The water heater appliance also includes a control panel in signal communication with the controller. The control panel includes a display. A method of operating the water heater appliance includes the controller receiving a set-point temperature from the control panel, determining an inlet temperature via the inlet temperature sensor, and indicating the inlet temperature on the display of the control panel via an inlet temperature indicator.

### FIELD OF THE INVENTION

The present subject matter relates generally to recreational vehicle water heaters, and more particularly to inlet temperature systems thereof.

### BACKGROUND OF THE INVENTION

Water heaters for use with recreational vehicles (RV) typically include a water tank in combination with an internal heating element. Most internal heating elements in water heaters used in recreational vehicles are dual fuel: liquid petroleum gas and electric heating. The water heater is mounted on the recreational vehicle in a convenient position connected to cold water supply and hot water outlet pipes, respectively receiving cold water from a suitable water supply source and for directing heated water for use in cooking, bathing, and the like.

Typical water heaters include an interface where users may adjust a set-point temperature of the water heated by the water heater appliance. However, when the water supply is significantly below the set point temperature, the water heater may not bring the water temperature all the way to the set point temperature, i.e., the water heater may not reach the desired temperature, by which a user may perceive the water heater appliance as faulty or of less quality.

Accordingly, a water heater appliance configured to detect the temperature of the incoming water would be desirable. Further, a recreational vehicle with a water heater appliance configured to provide the temperature of the incoming water to a user would be advantageous.

### BRIEF DESCRIPTION OF THE INVENTION

Aspects and advantages of the invention will be set forth in part in the following description, or may be apparent from the description, or may be learned through practice of the invention.

In one example embodiment, a water heater appliance for a recreational vehicle is provided. The water heater appliance defines a vertical direction, a lateral direction, and a transverse direction. The vertical, lateral, and transverse directions are mutually perpendicular. The water heater appliance includes a cabinet, and a heat exchanger positioned within the cabinet. A combustion chamber is positioned within the cabinet. The combustion chamber includes a burner assembly. The combustion chamber is in thermal communication with the heat exchanger. The water heater appliance also includes an inlet coupled to the cabinet. The inlet is fluidly coupled to an inlet tube, and the inlet tube is fluidly coupled to the heat exchanger. The inlet tube includes an inlet temperature sensor. A controller is positioned within the cabinet. The controller is in signal communication with the inlet temperature sensor. The water heater appliance also includes a control panel in signal communication with the controller. The control panel includes a display. The controller is configured to receive a set-point temperature from the control panel, determine an inlet temperature via the inlet temperature sensor, and indicate the inlet temperature on the display of the control panel via an inlet temperature indicator.

In another example embodiment, a method of operating a water heater appliance for a recreational vehicle is provided. The water heater appliance includes a cabinet, and a heat exchanger positioned within the cabinet. A combustion chamber is positioned within the cabinet. The combustion chamber includes a burner assembly. The combustion chamber is in thermal communication with the heat exchanger. The water heater appliance also includes an inlet coupled to the cabinet. The inlet is fluidly coupled to an inlet tube, and the inlet tube is fluidly coupled to the heat exchanger. The inlet tube includes an inlet temperature sensor. A controller is positioned within the cabinet. The controller is in signal communication with the inlet temperature sensor. The water heater appliance also includes a control panel in signal communication with the controller. The control panel includes a display. The method includes the controller receiving a set-point temperature from the control panel, determining an inlet temperature via the inlet temperature sensor, and indicating the inlet temperature on the display of the control panel via an inlet temperature indicator.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an example embodiment of a water heater appliance for a recreational vehicle, according to aspects of the present subject matter.

FIG. 2 provides a perspective view of the water heater appliance of FIG. 1, with a door of the water heater appliance removed, according to aspects of the present subject matter.

FIG. 3 provides a perspective, sectional view of the water heater appliance of FIG. 1, according to aspects of the present subject matter.

FIG. 4 provides a side view of the water heater appliance of FIG. 1, according to aspects of the present subject matter.

FIG. 5 provides a schematic of the water heater appliance of FIG. 1 in communication with a control panel, according to aspects of the present subject matter.

FIG. 6 provides a front view of the example control panel of FIG. 4, according to aspects of the present subject matter.

FIG. 7 provides an example flowchart illustrating aspects of operating a water heater appliance, according to aspects of the present subject matter.

FIG. 8 provides a flow chart illustrating an example method of operating a water heater appliance, according to aspects of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified.

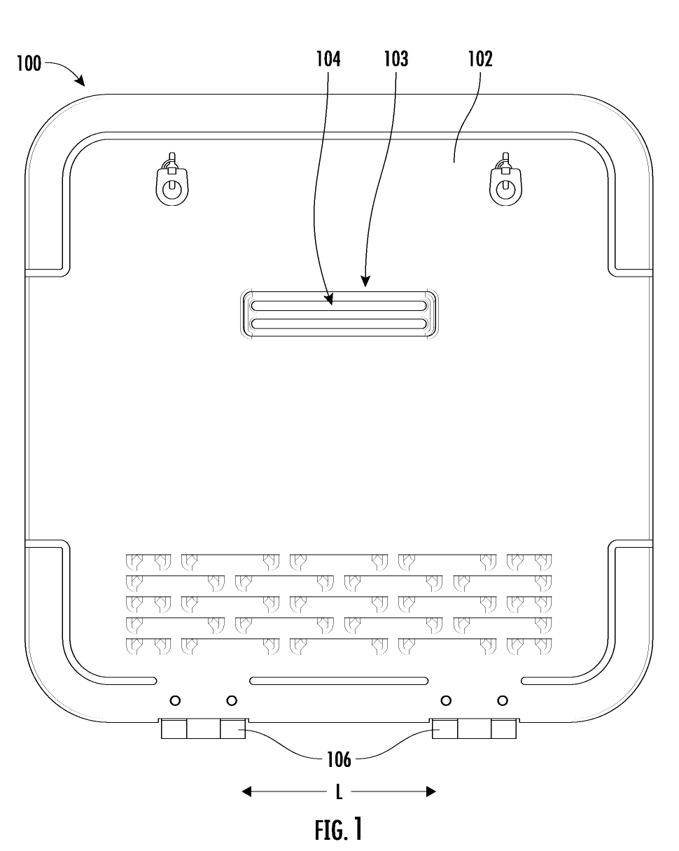

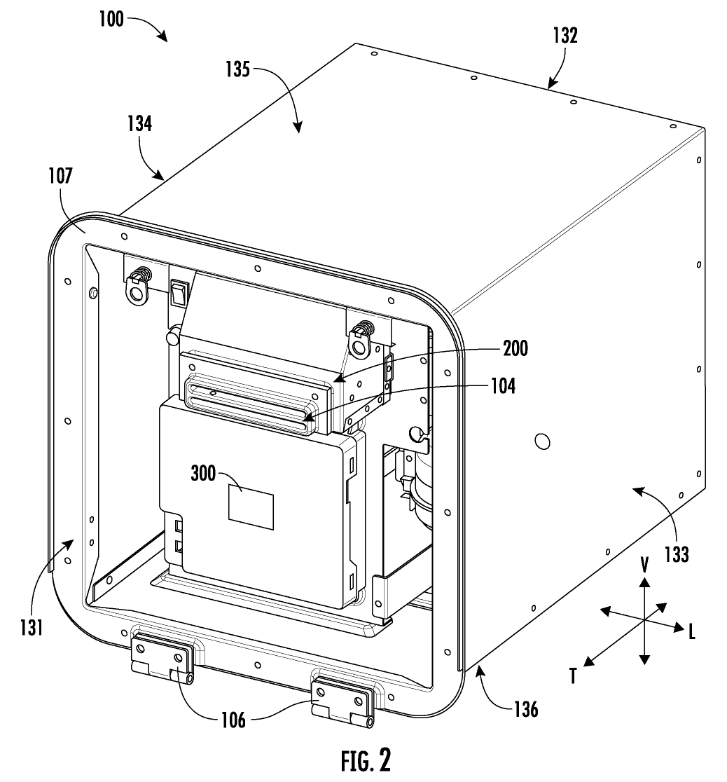

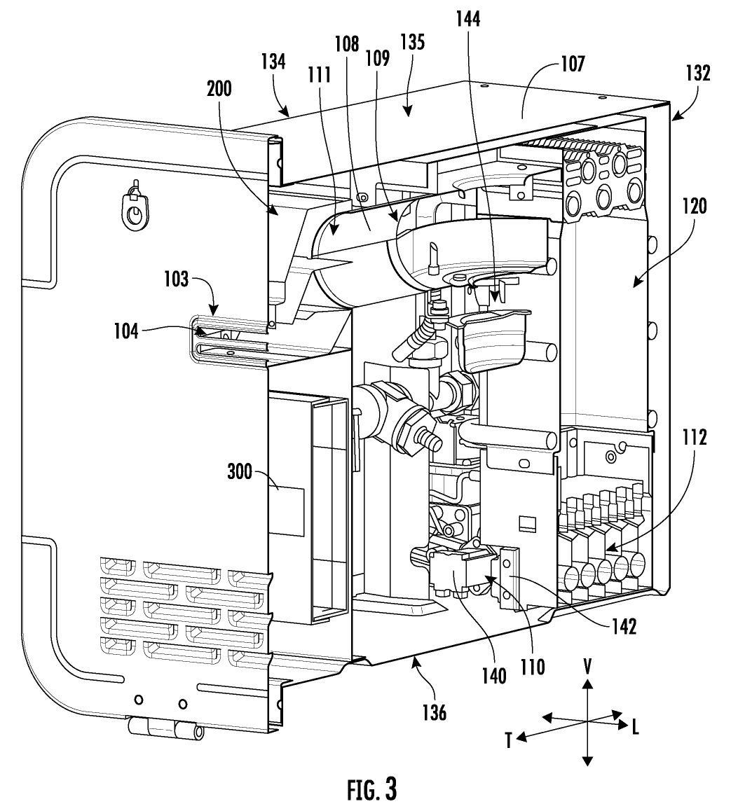

Referring now to FIGS. 1 through 3, an example tankless water heater appliance will be described in accordance with example aspects of the present subject matter. Specifically, FIG. 1 provides a front view of an example water heater appliance 100, FIG. 2 provides a perspective view of water heater appliance 100, and FIG. 3 provides a perspective, cross-sectional view of water heater appliance 100. As illustrated, water heater appliance 100 generally defines a vertical direction V, a lateral direction L, and a transverse direction T, each of which is mutually perpendicular, such that an orthogonal coordinate system is generally defined.

According to example embodiments, water heater appliance 100 may include a cabinet 107 that is generally configured for containing and/or supporting various components of water heater appliance 100 and which may also define one or more internal chambers or compartments of water heater appliance 100. In this regard, as used herein, the terms “cabinet,” “housing,” and the like are generally intended to refer to an outer frame or support structure for appliance 100, e.g., including any suitable number, type, and configuration of support structures formed from any suitable materials, such as a system of elongated support members, a plurality of interconnected panels, or some combination thereof. It should be appreciated that cabinet 107 does not necessarily require an enclosure and may simply include an open structure supporting various elements of appliance 100. By contrast, cabinet 107 may enclose some or all portions of the interior of cabinet 107. It should be appreciated that cabinet 107 may have any suitable size, shape, and configuration while remaining within the scope of the present subject matter.

In general, cabinet 107 may extend in the transverse direction T between a front side 131 and a back side 132, in the vertical direction V between a top side 135 and a bottom side 136, and in the lateral direction L between a first side 133 and a second side 134. In general, water heater appliance 100 may include a panel, e.g., a door 102, coupled to cabinet 107, as shown in FIG. 1 in a closed position, and removed in FIG. 2 for clarity in showing within cabinet 107. In general, door 102 may be mounted to cabinet 107 via hinges 106, e.g., hinges 106 may rotatably couple door 102 to cabinet 107. Opening door 102 about hinge 106 may permit selective access to internal components within cabinet 107, such as a burner assembly 110, a heat exchanger 120 and/or, an exhaust box 200, each of which are described in greater detail below. In general, door 102 of water heater appliance 100 may include a slot, such as an exhaust port 103, for an exhaust outlet 104, as will be described in greater detail below.

In the present example embodiment, water heater appliance 100 may include a heat exchanger 120 positioned within cabinet 107. Heat exchanger 120 may generally provide heat to water flowing through water heater appliance 100. For example, water heater appliance 100 may be a dual-fuel water heater. Thus, water heater appliance 100 may be configured for heating water by combusting liquid petroleum gas, such as liquid propane (LP). In general, water heater appliance 100 may also include a combustion chamber 112 within cabinet 107 for combusting liquid propane. As such, combustion chamber 112 may include a burner assembly 110 extending therein, and combustion chamber 112 may be in thermal communication with heat exchanger 120. In general, burner assembly 110 may include a gas inlet (not labeled) and a sparker or igniter 142 for igniting fuel within combustion chamber 112. In other words, burner assembly 110 may combust fuel within combustion chamber 112, thus providing heat to heat exchanger 120 for heating water passing through water heater appliance 100. Accordingly, water may enter water heater appliance 100 and be heated by heat exchanger 120, before being distributed to other appliances or outlets for use in cooking, bathing, and the like.

In general, burner assembly 110 may be in fluid communication with a gas control valve 140 to control the flow of gas to combustion chamber 112. Burner assembly 110 may generally create combustion products, such as exhaust gases within combustion chamber 112. In general, the created combustion products may exit water heater appliance 100 to ambient atmosphere. In particular, water heater appliance 100 may include an exhaust tube 108 fluidly coupled to combustion chamber 112. For example, exhaust tube 108 may extend between an inlet 109 positioned at combustion chamber 112 and an outlet 111 along the transverse direction T. In some example embodiments, a blower assembly 144 may be fluidly coupled between combustion chamber 112 and exhaust tube 108. Blower assembly 144 may generally be configured to pull exhaust from heat exchanger 120, through exhaust tube 108, and force the exhaust out of water heater appliance 100 to ambient atmosphere. In general, water heater appliance 100 may include a controller 300 positioned within cabinet 107 and configured to operate water heater appliance 100, as will be described further below.

In the present example embodiment, an exhaust box 200 may be positioned at outlet 111 of exhaust tube 108. Exhaust box 200 may generally be a rectangular, stainless-steel box. In particular, exhaust box 200 may be fluidly coupled to exhaust tube 108 and may include exhaust outlet 104, e.g., exhaust outlet 104 may be integral to exhaust box 200 and may extend through exhaust port 103 in door 102 of water heater appliance 100. As such, the created combustion products from burner assembly 110 may exit from water heater appliance 100 to ambient atmosphere from combustion chamber 112 through exhaust tube 108, into exhaust box 200, and through exhaust outlet 104. In some example embodiments, exhaust box 200 may be excluded, e.g., exhaust tube 108 may extend from blower assembly 144 to exhaust port 103.

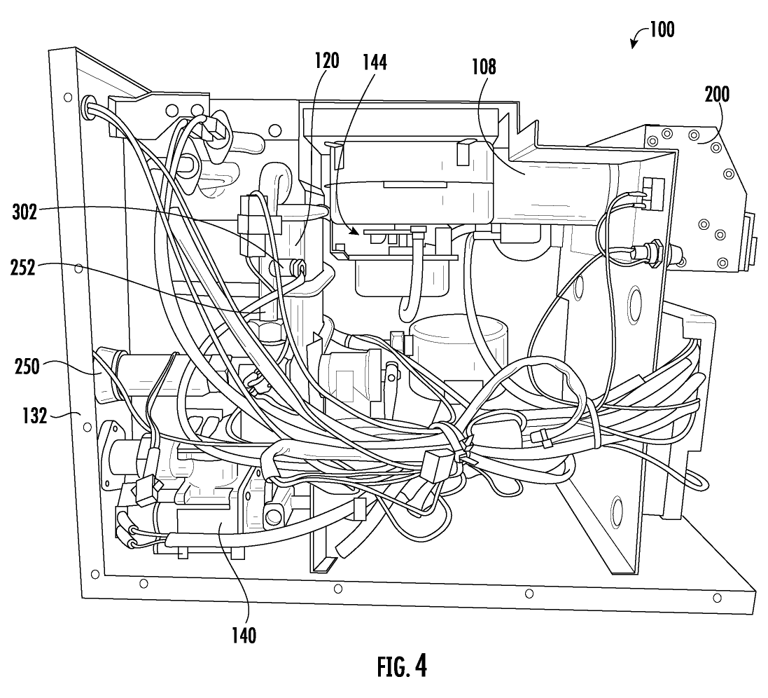

Turning now to FIG. 4, provided is a side view of water heater appliance 100, with portions of cabinet 107 removed for clarity of the components within water heater appliance 100. In general, water heater appliance 100 may include an inlet 250 coupled to cabinet 107. For example, inlet 250 may be coupled to and extend through back side 132 of cabinet 107. In general, inlet 250 may be coupled to an inlet tube 252, e.g., within cabinet 107 inlet 250 may be fluidly coupled to inlet tube 252. Inlet tube 252 may generally be fluidly coupled to heat exchanger 120, thereby extending between inlet 250 and heat exchanger 120. As such, water heater appliance 100 may receive water from an external water source, such as a water tank or a municipal water supply, through inlet 250 and direct the water through inlet tube 252 and into heat exchanger 120 for heating. As will be explained further below, inlet tube 252 may include an inlet temperature sensor 302 mounted thereon. In general, inlet temperature sensor 302 may be a thermistor.

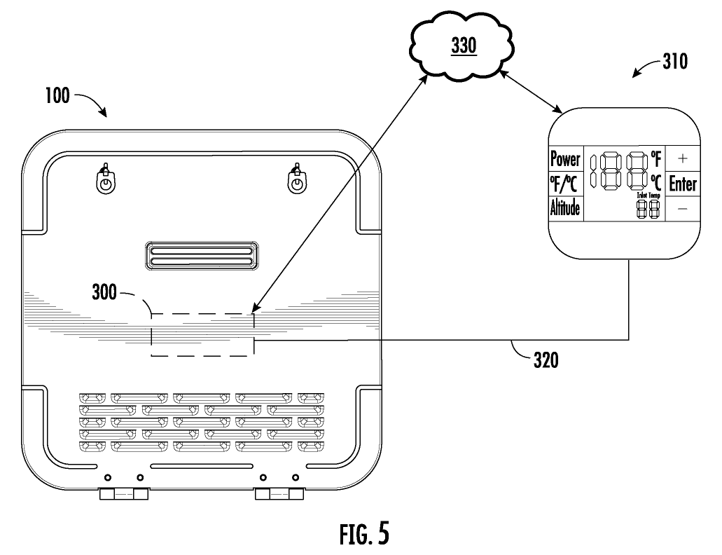

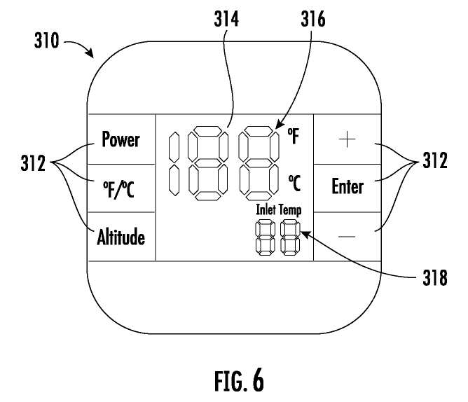

Turning now to FIGS. 5 and 6, water heater appliance 100 may generally include a control panel 310. In the present example embodiment, control panel 310 may be positioned separate from water heater appliance 100. For example, control panel 310 may be a wall-mounted user interface, or an external appliance controller, positioned within about five feet (5 ft), such as within about eight feet (8 ft), such as within about fifteen feet (15 ft) of water heater appliance 100. Control panel 310 may represent a general-purpose Input/Output (“GPIO”) device or functional block for water heater appliance 100. In some embodiments, control panel 310 may include or be in operative communication with a plurality of user input devices 312, such as one or more, or a variety, of digital, analog, electrical, mechanical, or electro-mechanical input devices including control knobs, push buttons, toggle switches, selector switches, and touch pads.

Additionally, water heater appliance 100 may include a display 314, such as a digital or analog display device generally configured to provide visual feedback regarding the operation of water heater appliance 100. For example, display 314 may be provided on control panel 310 and may include one or more status lights, screens, or visible indicators. According to example embodiments, user input devices 312 and display 314 may be integrated into a single device, e.g., including one or more of a touchscreen interface, a capacitive touch panel, a liquid crystal display (LCD), a plasma display panel (PDP), or other informational or interactive displays.

Water heater appliance 100 may further include or be in operative communication with a processing device, e.g., controller 300, that may be generally configured to facilitate appliance operation. In this regard, inlet temperature sensor 302, control panel 310, user input devices 312, and display 314 may be in signal communication with controller 300 such that controller 300 may determine temperature measurements from inlet temperature sensor 302, may receive user inputs from user input devices 312, may display information using display 314, and may otherwise regulate operation of water heater appliance 100. For example, signals generated by controller 300 may operate water heater appliance 100, including any or all system components, subsystems, or interconnected devices, in response to the interaction of user input devices 312 and other control commands. Control panel 310 and other components of appliance 100 may be in communication with controller 300 via, for example, one or more signal lines, e.g., wire 320, or shared communication busses. In this manner, Input/Output (“I/O”) signals may be routed between controller 300 and various operational components of water heater appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 300 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 300 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 300 may be operable to execute programming instructions or micro-control code associated with an operating cycle of water heater appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 300 as disclosed herein is capable of and may be operable to perform any methods, method steps, or portions of methods as disclosed herein. For example, in some embodiments, methods disclosed herein may be embodied in programming instructions stored in the memory and executed by controller 300.

The memory devices may also store data that can be retrieved, manipulated, created, or stored by the one or more processors or portions of controller 300. The data can include, for instance, data to facilitate performance of methods described herein. The data can be stored locally (e.g., on controller 300) in one or more databases and/or may be split up so that the data is stored in multiple locations. In addition, or alternatively, the one or more database(s) can be connected to controller 300 through any suitable network(s), e.g., network 330 (FIG. 4), such as through a high bandwidth local area network (LAN) or wide area network (WAN). In this regard, for example, controller 300 may further include a communication module or interface that may be used to communicate with one or more other component(s) of water heater appliance 100, controller 300, control panel 310, or any other suitable device, e.g., via any suitable communication lines (e.g., wire 320) or network(s) (e.g., network 330) and using any suitable communication protocol. The communication interface can include any suitable components for interfacing with one or more network(s), including for example, transmitters, receivers, ports, controllers, antennas, or other suitable components.

As stated above, display 314 may include one or more status lights, screens, or visible indicators. In particular, display 314 may include a set-point temperature indicator 316 and an inlet temperature indicator 318. In general, set-point temperature indicator 316 may display/project a numerical value indicative of the set-point temperature set by a user at control panel 310. In general, inlet temperature indicator 318 may display/project a numerical value indicative of an inlet temperature, e.g., an instantaneous temperature of incoming water into water heater appliance 100, measured by inlet temperature sensor 302.

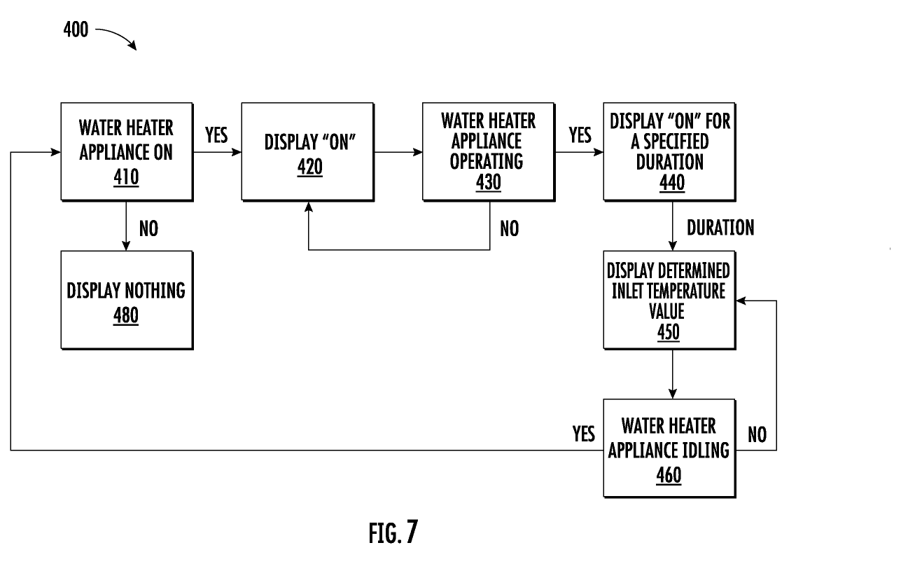

Turning now to FIG. 7, illustrated is an example flowchart 400 illustrating aspects of operating water heater appliance 100. In general, in some aspects of operating water heater appliance 100, at (410), controller 300 may determine if water heater appliance 100 is ON, e.g., powered ON and idling (e.g., not actively heating water). At (480), if water heater appliance 100 is determined to not be ON, then display 314 of control panel 310 may display/project/illuminate nothing, e.g., display 314 may be OFF. At (420), however, if water heater appliance 100 is determined to be ON, display 314 may display/project/illuminate an icon (e.g., as shown in FIG. 6 as “88” for inlet temperature indicator 318) such as “ON”, e.g., inlet temperature indicator 318 may display/project/illuminate “ON” while water heater appliance 100 is ON and idling. In general, the icon may be any suitable shape, pattern, word, or graphical symbol, such as “SENSING” or an illuminated “box” shape. In further example embodiments, the icon may be animated, such as to indicate loading, or more particularly, sensing of the inlet temperature, e.g., an illuminated “box” shape may rotate on display 314.

At (430), controller 300 may determine if water heater appliance 100 is operating, i.e., actively heating water to provide to various points of use, such as other appliances, such as a dishwasher appliance or washing machine appliance, or other points of use, including fixtures such as faucets, etc. For example, some recreational vehicles include a plurality of appliances therein, and water heater appliance 100 may be configured to supply heated water thereto. When controller 300 determines water heater appliance 100 is not operating, controller 300 may return to (420) and display/project/illuminate the icon, e.g., “ON”. When controller 300 determines water heater appliance 100 is operating, controller 300 may proceed to step (440). In general, step (440) may include beginning a specified duration of time which the icon is displayed on display 314. In general, the specified duration of time may be between about one second (1s) and about three hundred and sixty seconds (360s), such as between about two seconds (2s) and about three hundred (300s), such as between about three seconds (3s) and about two hundred and forty seconds (240s). In general, the specified duration of time may correlate to how long it takes for inlet temperature sensor 302 to determine the inlet temperature.

After the specified duration of time, at (450), display 314 of control panel 310 may display/project/illuminate the determined inlet temperature, e.g., the numerical value, such as displaying “65”. In particular, inlet temperature indicator 318 may display/project/illuminate the determined inlet temperature on display 314 of control panel 310. One of skill in the art would understand that the value “65” is provided for example and demonstrative purposes only, and the numerical value depicted on display 314 may be any suitable value as determined by inlet temperature sensor 302.

After displaying the determined inlet temperature, at (460), controller 300 may determine if water heater appliance 100 is idling. In particular, controller 300 may determine if water heater appliance 100 has idled at least for a second specified duration of time. If water heater appliance 100 has idled at least for the second specified duration of time, controller 300 may return to (410), and if water heater appliance 100 has not idled at least for the second specified duration of time, controller 300 may continue displaying the determined inlet temperature at (450). In general, the second specified duration of time may include between about ten seconds (10s) and about three hundred and sixty seconds (360s), such as between about twenty seconds (20s) and about three hundred (300s), such as between about thirty seconds (30s) and about two hundred and forty seconds (240s).

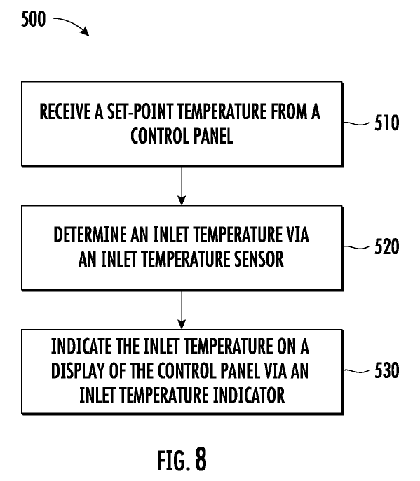

Turning now to FIG. 8, illustrated is a method 500 of operating water heater appliance 100. Method 500 may include steps performed in a particular order for purposes of illustration and discussion. Those of ordinary skill in the art, using the disclosures provided herein, will understand that the steps of any of the methods discussed herein may be adapted, rearranged, expanded, omitted, or modified in various ways without deviating from the scope of the present disclosure. Moreover, although aspects of method 500 are explained using water heater appliance 100 as an example, it should be appreciated that method 500 may be applied to the operation of any suitable appliance.

At 510, method 500 may generally include receiving the set-point temperature from control panel 310. For example, controller 300 may receive the set-point temperature of the water being heated by water heater appliance 100 from a user inputting, via the plurality of user input devices 312 of control panel 310, the set-point temperature on control panel 310.

At 520, method 500 may generally include determining an inlet temperature via inlet temperature sensor 302. As stated above, inlet tube 252 may include inlet temperature sensor 302 mounted thereon. As such, the temperature of water flowing into water heater appliance 100, e.g., through inlet 250 and inlet tube 252, may be measured by inlet temperature sensor 302. For example, inlet temperature sensor 302 may be a thermistor, such that a resistance of inlet temperature sensor 302 may change depending upon the temperature of the water flowing into water heater appliance 100. Accordingly, controller 300 may measure the resistance of inlet temperature sensor 302 in order to determine the inlet temperature of the water flowing into water heater appliance 100. In some example embodiments, determining the inlet temperature may occur directly in response to receiving the set-point temperature.

At 530, method 500 may generally include indicating the inlet temperature on display 314 of control panel 310 via inlet temperature indicator 318. As stated above, inlet temperature indicator 318 may display/project a numerical value indicative of an inlet temperature, e.g., of incoming water into water heater appliance 100, measured by inlet temperature sensor 302. Additionally, inlet temperature indicator 318 may be configured to display/project/illuminate the icon, such as “ON” while water heater appliance 100 is ON and idling. In the present example embodiment, in response to receiving the set-point temperature, e.g., in response to becoming active instead of idle, controller 300 may begin counting down the specified duration of time which the icon is displayed on display 314, e.g., the specified duration of time may correlate to how long it takes for inlet temperature sensor 302 to determine the inlet temperature. Accordingly, after the specified duration of time, display 314 of control panel 310 may display/project/illuminate the numerical value of the determined inlet temperature. Furthermore, after indicating the inlet temperature on display 314 of control panel 310, method 500 may further include displaying the inlet temperature indicator as the icon in response to the water heater appliance idling for longer than the second specified duration of time, as described above. As such, method 500 may advantageously provide a new combination of steps of operating a water heater appliance, such as water heater appliance 100.

In general, at a particular flow rate, water heater appliance 100 may provide water at the set-point temperature as long as a delta, or difference, between the set point temperature and the inlet temperature is within a threshold. When the delta exceeds the threshold, water heater appliance 100 may provide water at the set-point temperature at a reduced flow rate. For example, at a first flow rate of about 3.2 gallons per minute (GPM), water heater appliance 100 may provide water at the set-point temperature when a first delta between the set-point temperature and the inlet temperature is less than about thirty five degrees Fahrenheit (35°F). In the present example embodiment, if the delta between the set-point temperature and the inlet temperature increased to between about thirty five degrees Fahrenheit (35°F) and fifty degrees Fahrenheit (50°F), water heater appliance 100 may provide water at the set-point temperature at a second flow rate of about 2.0 gallons per minute (GPM). Furthermore, if the delta between the set-point temperature and the inlet temperature increased to between about fifty degrees Fahrenheit (50°F) and seventy degrees Fahrenheit (70°F), water heater appliance 100 may provide water at the set-point temperature at a third flow rate of about 1.4 gallons per minute (GPM). Accordingly, displaying the inlet temperature on display 314 may permit a user to calculate the delta between the set-point temperature and the inlet temperature, and make decisions, such as prioritizing using or operating certain appliances or fixtures, e.g., operating a dishwasher and/or running a shower.

As such, in some example embodiment, method 500 may include adjusting the set-point temperature in response to the determined inlet temperature. For example, either controller 300 or a user may adjust the set-point temperature, such as to reduce the delta between the set-point temperature and the inlet temperature, thereby increasing the flow rate at which the set-point temperature may be provided by water heater appliance 100.

As may be seen from the above, a tankless water heater appliance for a recreational vehicle may advantageously include a control panel configured to display the inlet temperature of the incoming water to a user. By displaying an instantaneous inlet temperature, a delta between the set-point temperature and the inlet temperature may be calculated to determine a flow rate of water heater appliance 100 to achieve the desired temperature. In particular, indicating the inlet temperature on a display of a control panel may provide an improved, e.g., more personalized, operation of the appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater appliance for a recreational vehicle, the water heater appliance defining a vertical direction, a lateral direction, and a transverse direction, the vertical, lateral, and transverse directions mutually perpendicular, the water heater appliance comprising:
a cabinet;
a heat exchanger positioned within the cabinet;
a combustion chamber positioned within the cabinet, the combustion chamber comprising a burner assembly, the combustion chamber in thermal communication with the heat exchanger;
an inlet coupled to the cabinet, the inlet fluidly coupled to an inlet tube, the inlet tube fluidly coupled to the heat exchanger, the inlet tube comprising an inlet temperature sensor;
a controller positioned within the cabinet, the controller in signal communication with the inlet temperature sensor; and
a control panel in signal communication with the controller, the control panel comprising a display,
wherein the controller is configured to:
receive a set-point temperature from the control panel;
determine an inlet temperature via the inlet temperature sensor, and
indicate the inlet temperature on the display of the control panel via an inlet temperature indicator.

2. The water heater appliance of claim 1, wherein the controller is configured to adjust the set-point temperature in response to the determined inlet temperature.

3. The water heater appliance of claim 1, wherein, while the water heater appliance is idle, the controller is configured to display the inlet temperature indicator as an icon.

4. The water heater appliance of claim 3, wherein, while determining the inlet temperature, the controller is configured to display the inlet temperature indicator as the icon for a specified duration of time.

5. The water heater appliance of claim 4, wherein the controller is configured to indicate the inlet temperature on the display of the control panel after the specified duration of time.

6. The water heater appliance of claim 1, wherein, after indicating the inlet temperature on the display of the control panel, the controller is configured to display the inlet temperature indicator as an icon in response to the water heater appliance idling for longer than a specified duration of time.

7. The water heater appliance of claim 1, wherein determining the inlet temperature occurs in response to receiving the set-point temperature.

8. The water heater appliance of claim 1, wherein the inlet temperature sensor comprises a thermistor.

9. The water heater appliance of claim 1, wherein the control panel comprises a plurality of user input devices.

10. The water heater appliance of claim 9, wherein the plurality of user input devices comprises one or more of control knobs, push buttons, toggle switches, selector switches, and touch pads.

11. A method of operating a water heater appliance for a recreational vehicle, the water heater appliance comprising a cabinet, a heat exchanger positioned within the cabinet, a combustion chamber positioned within the cabinet, the combustion chamber comprising a burner assembly, the combustion chamber in thermal communication with the heat exchanger, an inlet coupled to the cabinet, the inlet fluidly coupled to an inlet tube, the inlet tube fluidly coupled to the heat exchanger, the inlet tube comprising an inlet temperature sensor, a controller positioned within the cabinet, the controller in signal communication with the inlet temperature sensor, and a control panel in signal communication with the controller, the control panel comprising a display, the method comprising:
receiving, by the controller, a set-point temperature from the control panel;
determining, by the controller, an inlet temperature via the inlet temperature sensor, and
indicating, by the controller, the inlet temperature on the display of the control panel via an inlet temperature indicator.

12. The method of claim 11, further comprising adjusting, by the controller, the set-point temperature in response to the determined inlet temperature.

13. The method of claim 11, wherein, while the water heater appliance is idle, the method comprises displaying, by the controller, the inlet temperature indicator as an icon.

14. The method of claim 13, wherein, while determining the inlet temperature, the method comprises displaying, by the controller, the inlet temperature indicator as the icon for a specified duration of time.

15. The method of claim 14, wherein indicating the inlet temperature comprises indicating the inlet temperature on the display of the control panel after the specified duration of time.

16. The method of claim 11, wherein, after indicating the inlet temperature on the display of the control panel, the method comprises displaying, by the controller, the inlet temperature indicator as an icon in response to the water heater appliance idling for longer than a specified duration of time.

17. The method of claim 11, wherein determining the inlet temperature occurs in response to receiving the set-point temperature.

18. The method of claim 11, wherein the inlet temperature sensor comprises a thermistor.

19. The method of claim 11, wherein the control panel comprises a plurality of user input devices.

20. The method of claim 19, wherein the plurality of user input devices comprises one or more of control knobs, push buttons, toggle switches, selector switches, and touch pads.
